(19) United States
(12) Patent Application Publication
(10) Pub. No.: US 2025/0060245 A1
(43) Pub. Date: Feb. 20, 2025

(54) CLASSIFICATION DEVICE, CLASSIFICATION METHOD, AND PROGRAM

(71) Applicant: NIPPON TELEGRAPH AND TELEPHONE CORPORATION, Tokyo (JP)

(72) Inventors: Masaaki INOUE, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/722,505

(22) PCT Filed: Oct. 14, 2022
(86) PCT No.: PCT/JP2022/038289

§ 371 Date: Jun. 20, 2024

(30) Foreign Application Priority Data
Dec. 24, 2021 (WO) PCT/JP2021/048207

(51) Int. Cl. G01H 9/00

(52) U.S. Cl. CPC G01H 9/004

(57) ABSTRACT

A determination device 301 is a determination device that categorizes an installation environment of an optical cable 21, and includes a feature extraction unit 212 that extracts a feature vector at each position of the optical cable 21 from a vibration distribution in a longitudinal direction of the optical cable 21, a calculation unit 219 that calculates a discriminant function at each position of the optical cable 21 from the feature vector and a weight vector corresponding to the installation environment, in need of categorization, of the optical cable 21, and a determination unit 220 that compares the discriminant function with teacher signals representing two states and designates a state of the nearer of the teacher signals as a state of the optical cable 21, at each position of the optical cable 21.

### TECHNICAL FIELD

The present disclosure relates to a determination device that categorizes an installation environment of an optical cable, a determination method thereof, and a determination program thereof.

### BACKGROUND ART

In maintaining and managing an optical fiber communication network, accurate and fresh information management of optical facilities constituting the communication network is desired. In particular, skill required for an operator varies depending on an installation environment of an optical cable, and thus, it is important to have ability to determine which the environment is the underground or the overhead. Identification of a position of a utility pole and a location of cable slack also helps reduction in operation of the operator.

Remote monitoring and testing of optical cables include distance loss measurement by an optical time domain reflectometry (OTDR) method (for example, see Patent Literature 1) which is an optical evaluation method. The OTDR method is a method for measuring a distance loss of an optical fiber by connecting an optical tester to one core of the optical fiber in an optical cable, injecting pulsed light into the optical fiber and detecting, in a longitudinal direction of the optical fiber, light intensity of scattered light (backscattered light) propagating in a direction opposite to the pulsed light. The distance loss measurement by the OTDR method is useful for identifying a location of a failure of the optical cable, but cannot determine what installation environment of the optical cable is.

In recent years, narrowing of a line width of a laser has produced a distributed acoustic sensing (DAS) method for measuring vibration distribution from a change in a backscattered light waveform in a continuous optical fiber longitudinal direction (see, for example, Non Patent Literature 1). The method is a useful basis for detecting vibration applied to the optical cable from a surrounding environment using an optical fiber as a sensor through vibration distribution measurement, and for determining what installation environment of the optical fiber is.

### CITATION LIST

### Patent Literature

Patent Literature 1: JP H7-28266 A

### Non Patent Literature

Non Patent Literature 1: T. Okamoto, D. Iida, Y. Koshikiya and N. Honda, “Deployment Condition Visualization of Aerial Optical Fiber Cable by Distributed Vibration Sensing based on Optical Frequency Domain Reflectometry”, in Journal of Lightwave Technology, vol. 39, no. 21, pp. 6942-6951 Nov. 1, 2021, doi: 10.1109/JLT.2021.3107855 (27 Aug. 2021).
Non Patent Literature 2: Y. Wakisaka, D. Iida, H. Oshida and N. Honda, “Fading Suppression of ϕ-OTDR With the New Signal Processing Methodology of Complex Vectors Across Time and Frequency Domains”, in Journal of Lightwave Technology, vol. 39, no. 13, pp. 4279-4293 Jul. 1, 2021, doi: 10.1109/JLT.2021.3071159 (6 Apr. 2021).

### SUMMARY OF INVENTION

### Technical Problem

However, a vibration distribution measurement result obtained by the DAS method is a change in a magnitude of vibration in a continuous time domain in an optical cable longitudinal direction. Thus, there is a problem of difficulty in directly determining a factor in application of the vibration on the basis of only the measurement result although the different vibration is able to be known in different local ranges of the optical cable.

In other words, the present invention is directed to solving the following two problems:
(1) Interpreting meaning of a change in a magnitude of vibration in an optical cable longitudinal direction to categorize and determine an installation environment of the optical cable.
(2) Establishing a categorization and determination algorithm that is also applicable in various installation environments of the optical cable.

In order to solve the above problems, an object of the present invention is to provide a determination device, a determination method and a program capable of categorizing and determining various installation environments of an optical cable from a vibration distribution waveform.

### Solution to Problem

In order to achieve the above object, a determination device according to the present invention performs Fourier transform on a vibration distribution in a longitudinal direction of an optical cable, generates a discriminant function by multiplying frequencies of peaks of a spectrum and amplitudes thereof by weighting coefficients, compares the discriminant function with teacher data representing two installation environments (underground/overhead, the presence/absence of a utility pole, the presence/absence of cable slack) of the optical cable and designates a state of the nearer of the teacher data as an installation environment of the optical cable.

Specifically, a determination device according to the present invention is a determination device that categorizes an installation environment of an optical cable, and includes:
a feature extraction unit that extracts a feature vector at each position of the optical cable from a vibration distribution in a longitudinal direction of the optical cable;
a calculation unit that calculates a discriminant function at each position of the optical cable from the feature vector and a weight vector corresponding to the installation environment, in need of categorization, of the optical cable; and
a determination unit that compares the discriminant function with teacher signals representing two states and designates a state of the nearer of the teacher signals as a state of the optical cable, at each position of the optical cable.

Further, a determination method according to the present invention is a determination method for categorizing an installation environment of an optical cable, the determination method includes:
extracting a feature vector at each position of the optical cable from a vibration distribution in a longitudinal direction of the optical cable;
calculating a discriminant function at each position of the optical cable from the feature vector and a weight vector corresponding to the installation environment, in need of categorization, of the optical cable; and comparing the discriminant function with teacher signals representing two states and designating a state of the nearer of the teacher signals as a state of the optical cable, at each position of the optical cable.

The present determination device (method) uses a fact that an optical cable has vibration characteristics depending on an environment. Specifically, in determining whether the optical cable is buried underground or laid overhead, a weight vector, corresponding to determining whether environment of the optical cable is the underground or the overhead, is learned in advance, and a discriminant function is calculated from the weight vector and a feature vector of vibration of an optical fiber in an unknown environment. Then, determining whether the environment is the underground or the overhead is executed from a value of the discriminant function. In addition, when the weight vectors to be learned in advance are those of other environments (for example, the presence/absence of a utility pole, the presence/absence of cable slack, and the like), the weight vectors can be applied to categorization and determination of various environments.

Thus, the present invention can provide a determination device and a determination method capable of categorizing and determining various installation environments of an optical cable from a vibration distribution waveform.

For example, the feature extraction unit Fourier-transforms the vibration distribution from a waveform in a time domain to a spectrum waveform in a frequency domain, extracts frequencies of peaks and respective amplitudes of the peaks from the spectrum waveform and sorts the frequencies and the amplitudes into descending order of the amplitudes of the peaks to obtain the feature vector.

For example, the weight vector may be composed of coefficients for being multiplied by the frequencies and the respective amplitudes of the peaks correspondently, and the calculation unit may add values obtained by multiplying the frequencies and the respective amplitudes of the peaks by the coefficients of the weight vector correspondently to obtain the discriminant function.

The feature extraction unit may
Fourier-transform the vibration distribution from a waveform in a time domain to a spectrum waveform in a frequency domain,
remove a fluctuation component from components having a period in a frequency axis direction of the spectrum waveform,
extract frequencies of peaks and amplitudes of the peaks from the spectrum waveform from which the fluctuation component has been removed, and
configure the feature vector using the extracted frequencies of the peaks and amplitudes of the peaks.

The feature extraction unit may remove the fluctuation component by
logarithmizing absolute values of the amplitudes of the spectrum waveform,
calculating a time waveform of components having a period in a frequency axis direction of the logarithmized spectrum waveform from the logarithmized spectrum waveform, and
extracting a time domain having a value smaller than a predetermined threshold period in the time waveform.

By removing the fluctuation component, it is practical to extract a feature amount essential for discriminant of the installation environment of the optical cable, so that discriminant accuracy can be improved. Furthermore, the number of dimensions of the feature vector is reduced by extracting the feature amount that is essentially necessary, so that calculation resources can be optimized.

Note that the present determination device prepares a weight vector as follows.

The present determination device further includes a discriminant dictionary including a dictionary calculation unit and an update unit,
the feature extraction unit extracts a known feature vector at each position of the optical cable from a vibration distribution in a longitudinal direction of the optical cable in each of the two states,
the dictionary calculation unit calculates a known discriminant function at each position of the optical cable from the known feature vector and the weight vector, and
the update unit calculates, at each position of the optical cable, an error between the known feature vector in each of the two states and the teacher signal representing a relevant state of the two states and updates the weight vector so as to reduce the error.

Further, the discriminant dictionary settles the weight vector under condition that a square value of the error is a minimum and fluctuation of the error before and after update of the weight vector is equal to or less than a threshold.

In the present determination method, a weight vector is prepared as follows. The determination method further includes:
extracting a known feature vector at each position of the optical cable from a vibration distribution in a longitudinal direction of the optical cable in each of the two states;
calculating a known discriminant function at each position of the optical cable from the known feature vector and the weight vector;
calculating, at each position of the optical cable, an error between the known feature vector in each of the two states and the teacher signal representing a relevant state of the two states; and
updating the weight vector so as to reduce the error.

The present invention is a program for instructing a computer to function as the determination device. The determination device according to the present invention can also be implemented on a computer and in a program. The program can be recorded in a recording medium and can also be provided via a network.

Note that each of the inventions can be combined in any possible manner.

### Advantageous Effects of Invention

The present invention can provide a determination device, a determination method and a program capable of categorizing and determining various installation environments of an optical cable from a vibration distribution waveform.

### BRIEF DESCRIPTION OF DRAWINGS

FIG. 1 is a conceptual diagram illustrating a determination method according to the present invention.

FIG. 2 is a view illustrating the determination device according to the present invention.

FIG. 3 is a view illustrating detection of a vibration distribution by optical testing (C-OFDR).

FIG. 4 is a view illustrating work to be performed by a feature extraction unit of the determination device according to the present invention.

FIG. 5 is a view illustrating a task performed by a categorization determination unit of the determination device according to the present invention.

FIG. 6 is a view illustrating the determination device according to the present invention.

FIG. 7 is a view illustrating selection and extraction of a feature vector from an envelope of a Fourier spectrum.

FIG. 8 is a view illustrating categorization and determination of an installation environment of a cable using a discriminant function.

### DESCRIPTION OF EMBODIMENTS

Embodiments of the present invention will be described with reference to the accompanying drawings. The embodiments to be described below are examples of the present invention and the present invention is not limited to the embodiments described below. Note that components having the same reference numerals in the present description and the drawings denote the same components.

### SUMMARY OF INVENTION

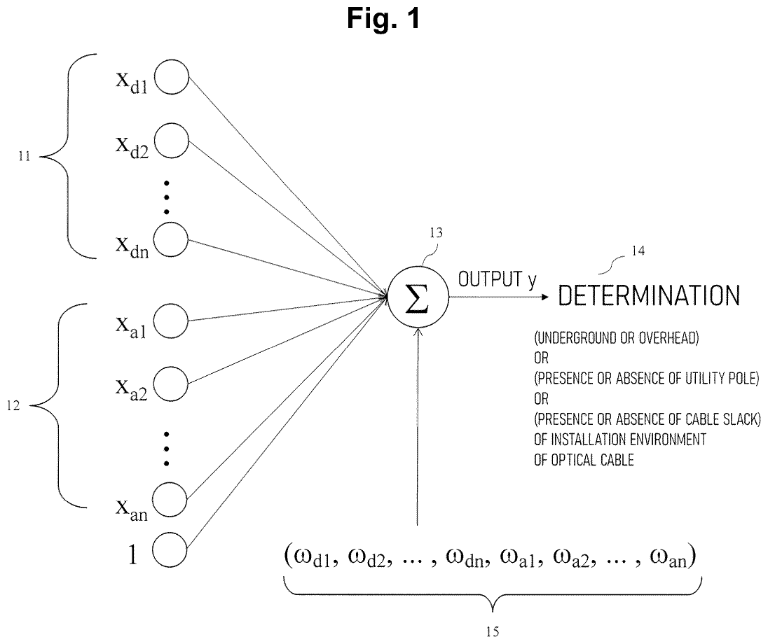

FIG. 1 is a view illustrating a calculation method performed by a determination device according to the present embodiment. In FIG. 1, each reference numeral indicates the following. 11: peak frequency of Fourier spectrum, 12: peak amplitude of Fourier spectrum, 13: linear sum, 14: output value y, 15: weight vector.

The present calculation method outputs one value in response to a plurality of input signals. Classes of the input signals are categorized on the basis of an output result. In the present invention, the peak frequency 11 (x_{d1}, x_{d2}, . . . , x_{dn}) and the peak amplitude 12 (xₐ₁, xₐ₂, . . . , xₐₙ) of a Fourier spectrum are defined as two kinds of feature amounts (feature vectors) that are the input signals, and the output value y 14 of the linear sum 13 obtained by multiplying these variables by coefficients (weight vector 15 (ω_{d1}, ω_{d2}, . . . , ω_{dn}, ωₐ₁, ωₐ₂, . . . , ωₐₙ)) is set as a discriminant function. The categorization (underground/overhead), (the presence/absence of a utility pole), or (the presence/absence of cable slack) of an installation environment of an optical cable is determined by a value of the discriminant function.

### First Embodiment

Hereinafter, a feature amount (feature vector) extraction method, a linear sum calculation method, and a categorization determination method will be described in detail.

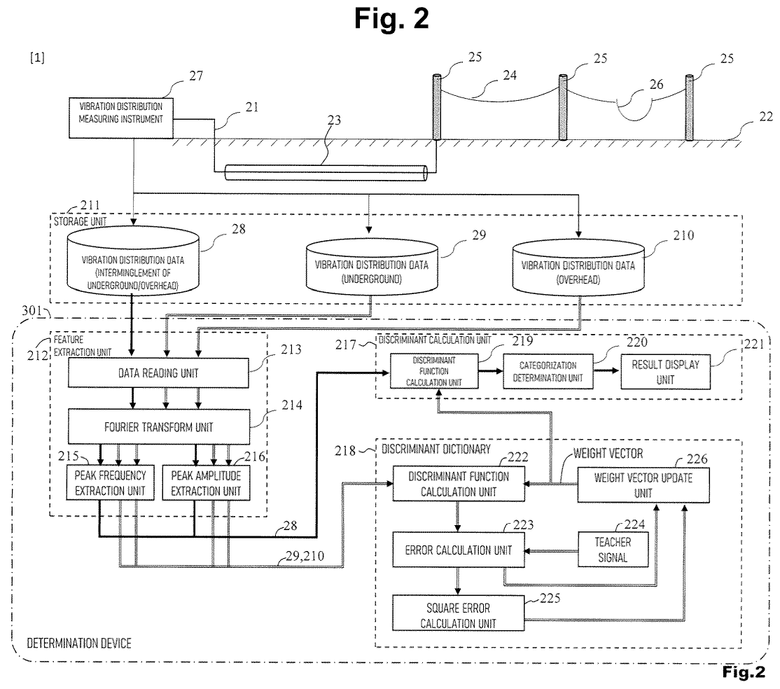

FIG. 2 is a view illustrating a determination device 301 of the present embodiment. The determination device 301 is a determination device that categorizes an installation environment of an optical cable 21, and includes:
a feature extraction unit 212 that extracts a feature vector at each position of the optical cable 21 from a vibration distribution in a longitudinal direction of the optical cable 21;
a calculation unit 219 that calculates a discriminant function at each position of the optical cable 21 from the feature vector and a weight vector corresponding to the installation environment, in need of categorization, of the optical cable 21; and
a determination unit 220 that compares the discriminant function with teacher signals representing two states and designates a state of the nearer of the teacher signals as a state of the optical cable 21, at each position of the optical cable 21.

In FIG. 2, each reference numeral indicates the following.
21: optical cable, 22: ground, 23: underground, 24: overhead, 25: utility pole, 26: slack, 27: vibration distribution measuring instrument, 28: first vibration distribution data, 29: second vibration distribution data, 210: third vibration distribution data, 211: storage unit, 212: feature extraction unit, 213: data reading unit, 214: Fourier transform unit, 215: peak frequency extraction unit, 216: peak amplitude extraction unit, 217: discriminant calculation unit, 218: discriminant dictionary, 219: discriminant function calculation unit, 220: categorization determination unit, 221: result display unit, 222: discriminant function calculation unit, 223: error calculation unit, 224: teacher signal, 225: square error calculation unit, 226: weight vector update unit.

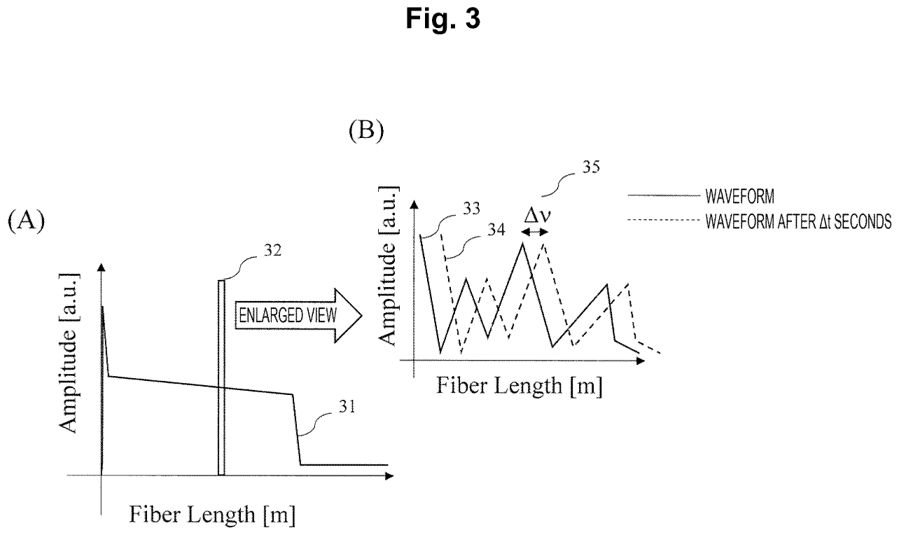

The installation environments of the optical cable 21 are divided into the underground 23 and the overhead 24 by the ground 22 as a boundary, and the optical cable is laid between the utility poles 25 in the overhead. In addition, in an abnormal installation state, the slack 26 may locally occur, and there is a possibility that repair work is required. It is an object of the present invention to categorize and determine the installation environment of the optical cable by optical testing. In the optical testing, the vibration distribution measuring instrument 27 is installed at one end of the optical cable 21, and a distribution of vibrations in the optical cable longitudinal direction is detected by a distributed acoustic sensing method (DAS) (for example, see Non Patent Literature 1 and Non Patent Literature 2) using a coherent optical frequency domain reflectometry (C-OFDR) or a coherent optical time domain reflectometry (C-OTDR) which will be described later with reference to FIG. 3. By continuously detecting the vibration distribution, three-dimensional data of magnitudes of distance-time-vibration of the optical cable can be acquired. Hereinafter, the three-dimensional data is referred to as vibration distribution data. The vibration distribution data includes vibration components in various installation environments of the optical cable such as underground, overhead, a position of a utility pole, and cable slack.

In the present embodiment, an example of categorizing and determining whether the installation environment of the cable 21 is the underground or the overhead will be described. Regarding categorization and determination of the presence or absence of a position of a utility pole and the presence or absence of cable slack, each wording thereof may be a replacement for a wording of categorization and determination of underground or overhead as mentioned below.

In order to categorize and determine the installation environment of the optical cable, the vibration distribution measuring instrument 27 acquires three pieces of vibration distribution data. The first vibration distribution data 28 is data requiring a grasp of the installation environments of the optical cable and is vibration distribution data of interminglement of an environment where the optical cable is laid underground and an environment where the optical cable is laid overhead. The second vibration distribution data 29 is vibration distribution data measured in advance only in an environment where the optical cable is laid underground. Similarly to the second vibration distribution data 29, the third vibration distribution data 210 is vibration distribution data measured in advance only in an environment where the optical cable is laid overhead. The second vibration distribution data 29 and the third vibration distribution data 210 are used as learning data, and thus, the environments therein are preferably different from the installation environments in the first vibration distribution data 28. The three pieces of vibration distribution data are stored in the storage unit 211.

The vibration distribution data 28, 29, and 210 are transmitted to the feature extraction unit 212. The data reading unit 213 independently reads the vibration distribution data 28, 29, and 210 and passes the data to a subsequent process. The Fourier transform unit 214 transforms magnitudes of vibration continuously observed at each point in the optical cable longitudinal direction of the vibration distribution data 28, 29, and 210 passed from the data reading unit 213 in a time domain to those in a frequency domain. Thus, the Fourier transform unit 214 transforms the three-dimensional data of magnitudes of distance-time-vibration of the optical cable of the vibration distribution data 28, 29, and 210 into three-dimensional data of magnitudes of distance-frequency-amplitude of the optical cable (Fourier spectrum data in the optical cable longitudinal direction).

The Fourier spectrum data are severally passed to the peak frequency extraction unit 215 and the peak amplitude extraction unit 216. The peak frequency extraction unit 215 extracts a peak frequency 11 (x_{d1}, x_{d2}, . . . , x_{dn}) of the Fourier spectrum from the Fourier spectrum data at each point in the optical cable longitudinal direction. Furthermore, the peak amplitude extraction unit 216 extracts a peak amplitude 12 (xₐ₁, xₐ₂, . . . , xₐₙ) of the Fourier spectrum. The peak frequency 11 (x_{d1}, x_{d2}, . . . , xₐₙ) and the peak amplitude 12 (xₐ₁, xₐ₂, . . . , xₐₙ) of the extracted Fourier spectrum are passed to a subsequent process as feature amounts (feature vectors). The feature amounts (feature vectors) of the first vibration distribution data 28 are passed to the discriminant calculation unit 217. The feature amounts (known feature vectors) of the second vibration distribution data 29 and the third vibration distribution data 210 are passed to the discriminant dictionary 218.

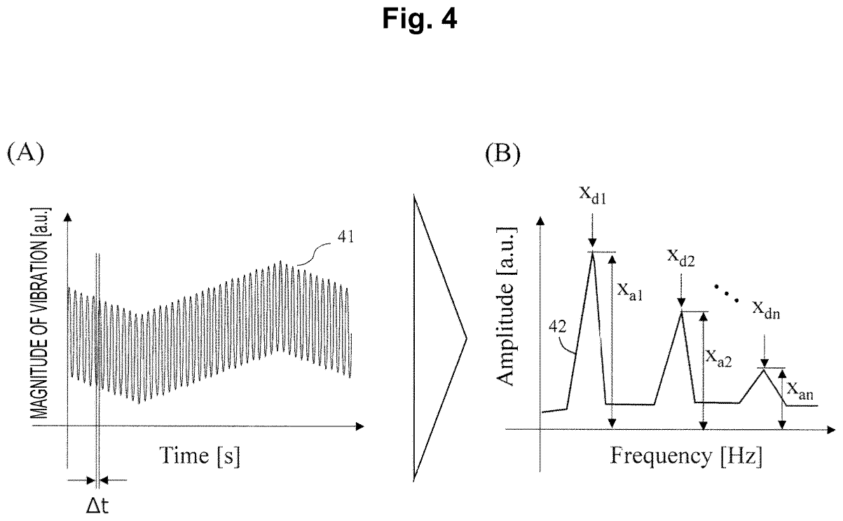

The Fourier transform performed by the feature extraction unit 212 and definition of the feature vectors will be described later with reference to FIG. 4.

The feature amounts (feature vectors) of the first vibration distribution data 28 passed to the discriminant calculation unit 217 are passed to the discriminant function calculation unit 219 as input signals, and one output value y 14 is calculated as illustrated in FIG. 1. The output value y 14 is a discriminant function. A calculation method of the discriminant function calculation unit 219 will be described. The feature amounts (feature vectors) (x_{d1}, x_{d2}, . . . , x_{dn} and xₐ₁, xₐ₂, . . . , xₐₙ) of the first vibration distribution data 28 are 2n+1 input signals (x_{d1}, x_{d2}, . . . , x_{dn}, xₐ₁, xₐ₂, . . . , xₐₙ, 1). In addition, 2n+1 coefficients (weight vectors) (ω_{d1}, ω_{d2}, . . . , ω_{dn}, ωₐ₁, ωₐ₂, . . . , ωₐₙ, ω₀), to be respectively multiplied by the input signals, are received from the discriminant dictionary 218, and the discriminant function calculation unit 219 calculates the following linear sum.

[Math. 1]

$${ω}_{d 1} {x}_{d 1} + {ω}_{d 2} {x}_{d 2} + … + {ω}_{dn} {x}_{dn} + {ω}_{a 1} {x}_{a 1} + {ω}_{a 2} {x}_{a 2} + … + {ω}_{an} {x}_{an} + {ω}_{0} = {ω}_{0} + {\sum }_{i = 1}^{n} ( {ω}_{di} {x}_{di} + {ω}_{ai} {x}_{ai} ) = y \qquad ( 1 )$$

The linear sum is an output value (discriminant function) of a specific point in the longitudinal direction of the optical cable 21.

Provided that a distance in the longitudinal direction of the optical cable 21 is constituted with L points, the discriminant function calculation unit 219 calculates L (y₀, y₁, . . . , y_{L-1}) from the feature amounts (feature vectors) of all the passed first vibration distribution data 28. The calculated discriminant function (y₀, y₁, . . . , y_{L-1}) is passed to the categorization determination unit 220.

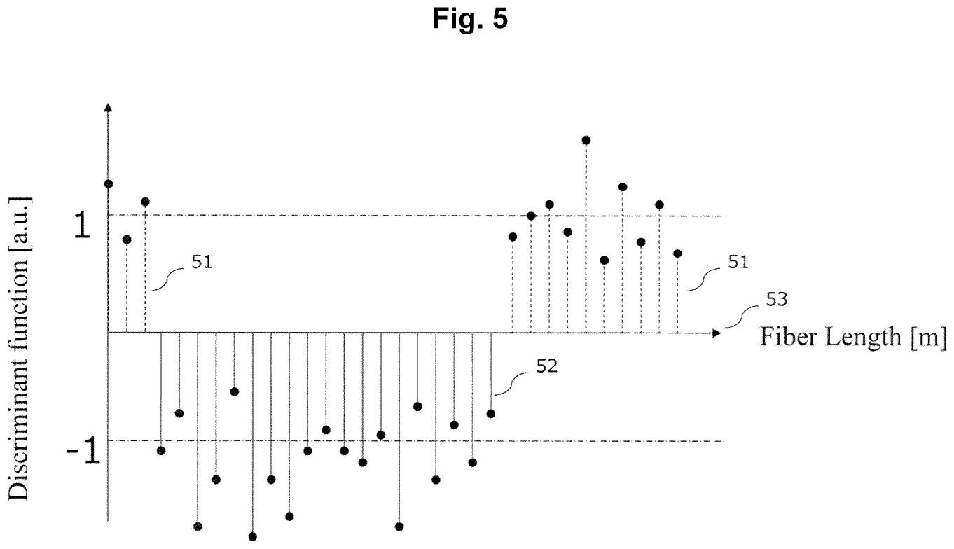

The categorization determination unit 220 compares each discriminant function (y₀, y₁, . . . , y_{L-1}) with teacher signals set in advance for each category and categorizes the discriminant function into a category of the nearest of the teacher signals. For example, the teacher signal “−1” is set as a category of the environment where the optical cable is laid underground, the teacher signal “1” is set as a category of the environment where the optical cable is laid overhead, and 0 is set as a threshold. An assumed discriminant function (y₀ (negative), y₁ (positive), . . . , y_{L-1} (positive)), when a negative value is determined to be underground and a positive value is determined to be overhead, is categorized as (underground, overhead, . . . , overhead). Categorization and determination performed by the categorization determination unit 220 will be described later with reference to FIG. 5.

The categorized result is passed to the result display unit 221, and the installation environment of the optical cable in the optical cable longitudinal direction is displayed as underground or overhead.

Discriminant accuracy in the categorization and determination varies depending on the weight vector (ω_{d1}, ω_{d2}, . . . , ω_{dn}, ωₐ₁, ωₐ₂, . . . , ωₐₙ, ω₀) received from the discriminant dictionary 218. A method of updating the weight vector will be described below.

The determination device 301 further includes the discriminant dictionary 218 including dictionary calculation units (222, 223, 225) and an update unit (226). The feature extraction unit 212 extracts a known feature vector (29, 210) at each position of the optical cable from the vibration distribution in the longitudinal direction of the optical cable in each of the two states (for example, underground and overhead).

The dictionary calculation unit 222 calculates a known discriminant function at each position of the optical cable from the known feature vector and the weight vector. The update unit 226 calculates, at each position of the optical cable, an error between the known feature vector in each of the two states and a teacher signal 224 representing a relevant state of the two states and updates the weight vector so as to reduce the error.

The feature amounts (known feature vectors) of the second vibration distribution data 29 and the third vibration distribution data 210 passed to the discriminant dictionary 218 are passed to the discriminant function calculation unit 222 as input signals. In this regard, similarly to the discriminant calculation unit 217, the feature amounts (known feature vectors) (x_{d1}, x_{d2}, . . . , xₐₙ and xₐ₁, xₐ₂, . . . , xₐₙ) of the second or third vibration distribution data are 2n+1 input signals (x_{d1}, x_{d2}, . . . , x_{dn}, xₐ₁, xₐ₂, . . . , xₐₙ, 1). The discriminant function calculation unit 222 calculates a known discriminant function in a similar manner to in Expression 1 on the basis of weight vectors (ω_{d1}, ω_{d2}, . . . , ω_{dn}, ωₐ₁, ωₐ₂, . . . , ωₐₙ, ω₀) of 2n+1 elements appropriately set in advance as initial values. Here, the known discriminant function y of one point of the distance, in a longitudinal direction of the optical cable, constituted with the L points is calculated. The calculated known discriminant function y is passed to the error calculation unit 223, and an error (y−bᵢ) in the teacher signal 224 set in advance for each category is calculated.

Here, bᵢ is a teacher signal (for example, a category of underground is “−1”, and a category of overhead is “1”).

In addition, the error is passed to the square error calculation unit 225, and the following square error is calculated.

(y−bᵢ)²

The calculated square error is passed to the weight vector update unit 226. Meanwhile, the error is passed to the weight vector update unit 226, and the weight vector is updated by the following expression.

[Math. 2]

$$( {{ω}^{″}}_{d 1} , {{ω}^{′}}_{d 2} , … , {{ω}^{′}}_{dn} , {{ω}^{′}}_{a 1} , {{ω}^{′}}_{a 2} , … , {{ω}^{′}}_{an} , {{ω}^{′}}_{0} ) = ( {ω}_{d 1} , {ω}_{d 2} , … , {ω}_{dn} , {ω}_{a 1} , {ω}_{a 2} , … , {ω}_{an} , {ω}_{0} ) - ρ ( y - {b}_{i} ) ( {x}_{d 1} , {x}_{d 2} , … , {x}_{dn} , {x}_{a 1} , {x}_{a 2} , … , {x}_{an} , 1 ) \qquad ( 2 )$$

Here, ρ is a learning coefficient (arbitrary unit).

The updated weight vector (ω′_{d1}, ω′_{d2}, . . . , ω′_{dn}, ω′ₐ₁, ω′ₐ₂, . . . , ωₐₙ, ω′₀) is passed to the discriminant function calculation unit 222, and the discriminant function is calculated as the weight vector (∫_{d1}, ω_{d2}, . . . , ω_{dn}, ωₐ₁, ωₐ₂, . . . , ωₐₙ, ω₀) in accordance with Expression 1.

The discriminant dictionary 218 repeatedly calculates Expressions 1 to 4. When each of the feature amounts (known feature vectors) of the second vibration distribution data 29 and the third vibration distribution data 210 has a distance constituted with L points in the optical cable longitudinal direction, the process is repeated 2L times or more. The repetition ends under condition that the square error calculated by the square error calculation unit 225 is a minimum value and stable. In this regard, the following may be used for calculation of the square error.

Σ((y₀,y₁, . . . ,y_{L-1})−bᵢ)²

The weight vector (ω_{d1}, ω_{d2}, . . . , ω_{dn}, ωₐ₁, ωₐ₂, . . . , ωₐₙ, ω₀) updated until obtainment of the minimum value and stableness of the square error is used in the discriminant function calculation unit 219.

### [Supplementary Description 1]

FIG. 3 is a view illustrating detection of a vibration distribution by optical testing (C-OFDR) performed by the vibration distribution measuring instrument 27. In FIG. 3, each reference numeral indicates the following. 31: light intensity distribution, 32: local section, 33: waveform pattern, 34: waveform pattern after Δt seconds, 35: change Δν.

FIG. 3(A) is a light intensity distribution in the entire longitudinal direction of optical fiber, and FIG. 3(B) is a waveform in which the light intensity of the local section 32 is enlarged and displayed.

In the C-OFDR of related art, the light intensity distribution 31 in a longitudinal direction of an optical fiber is measured. A laser beam is injected into an optical fiber in an optical cable, and backward Rayleigh scattered light propagating in a direction opposite to an incident direction is received to observe a change in light intensity. Focusing on a light intensity waveform in a local section 32, a waveform depending on characteristics unique to the optical fiber can be observed, and the waveform exhibits the same waveform pattern 33 with the state of the optical fiber, the laser beam, or the like, unchanged. A center wavelength of the laser beam having a wide line width always changes, and the waveform pattern also changes.

On appearing by virtue of progress of laser technology, a narrow-linewidth laser solves a problem in the influence of the change in the center wavelength, and produces the same pattern of the waveform with the optical fiber state being the same. Here, when vibration unique to the optical fiber is applied, the waveform pattern 34 after Δt seconds is different due to the influence of the vibration. Vibration is detected from a change Δν35 between the waveform pattern 33 and the waveform pattern 34.

A vibration distribution in the longitudinal direction of the optical fiber is detected by moving the local section 32. In addition, by continuously measuring the light intensity distribution and detecting vibration each time, it is practical to observe a temporal change in vibration in the longitudinal direction of the optical fiber. In this way, three-dimensional vibration distribution data of magnitudes of distance-time-vibration of the optical cable is acquired. In the C-OTDR, the vibration distribution is detected by focusing on a change in phase information obtained from the waveform pattern.

### [Supplementary Description 2]

FIG. 4 is a view for explaining the Fourier transform, performed by the feature extraction unit 212, and definition of the feature vector. In FIG. 4, each reference numeral indicates the following. 41: waveform g(t), 42: Fourier spectrum.

FIG. 4(A) illustrates the waveform 41 g(t), and FIG. 4(B) is a view illustrating a Fourier spectrum obtained by Fourier-transforming the waveform 41 g(t).

The waveform 41 g(t) indicating a continuous change in vibration in the local section 32 indicates the magnitude of vibration in the time direction at a plot interval Δt. An example of a formula for transforming the time domain into the frequency domain will be described below.

[Math. 3]

$$F ( ω ) = {\int }_{- ∞}^{∞} g ( t ) {e}^{- j 2 π ft} \qquad ( 3 )$$

Here, F(@) is a waveform obtained by transforming the waveform g(t) into a frequency domain, and f is a frequency [Hz].

The waveform g(t) is transformed into a frequency domain and turns the Fourier spectrum 42. In the Fourier spectrum 42, peaks are observed at specific frequencies corresponding to components of vibration. Frequencies of the spectrum peaks are assigned as x_{d1}, x_{d2}, . . . , and x_{dn}, and amplitudes are assigned as xₐ₁, xₐ₂, . . . , and xₐₙ in descending order of the peak values. These processes are performed in the entire optical fiber longitudinal direction by moving the local section 32. The extracted peak frequencies (x_{d1}, x_{d2}, . . . , x_{dn}) and peak amplitudes (xₐ₁, xₐ₂, . . . , xₐₙ) are passed as feature amounts (feature vectors or known feature vectors) to the discriminant calculation unit 217 or the discriminant dictionary 218.

### [Supplementary Description 3]

FIG. 5 is a view illustrating categorization and determination performed by the categorization determination unit 220. Here, the view explains an example of a teacher signal “−1” set as a category of the environment where the optical cable is laid underground, and a teacher signal “1” set as a category of the environment where the optical cable is laid overhead. Here, 51: positive discriminant function, 52: negative discriminant function, and 53: threshold.

Given that the discriminant functions calculated by the discriminant function calculation unit 219 are arranged at each distance in the optical cable longitudinal direction, a graph in which the positive discriminant function 51 and the negative discriminant function 52 are mixed is obtained. “0” which is an intermediate value of the teacher signal is set as the threshold 53, and the negative discriminant function 52 is categorized and designated as “underground” and the positive discriminant function 51 is categorized and designated as “overhead”. The value nearer to the teacher signal of “−1” or “1” indicates that the environment is nearer to the underground or overhead vibration distribution data learned by the discriminant dictionary. By using the algorithm of the present invention, it is practical to categorize the installation environments of the optical cable into two categories from the vibration distribution waveform.

### Second Embodiment

The frequency component may include a signal component that is not essential as a feature for discriminant of the surrounding environment and is considered as a factor of degrading accuracy. In addition, in order to obtain high discriminant accuracy, a high-dimensional feature vector is required, which requires a large amount of operation resources for learning.

Thus, the present embodiment solves the following problems.

First, a feature amount essential for discriminant of an installation environment of an optical cable is extracted to improve discriminant accuracy.

Secondly, the number of dimensions of the feature vector is reduced by configuring the feature vector having a selected feature amount, which is essentially necessary.

An object of the present embodiment is to provide a technique for discriminant of an installation environment of an optical cable using a machine learning method by selecting and extracting a feature vector, which is essentially necessary, from a vibration distribution waveform.

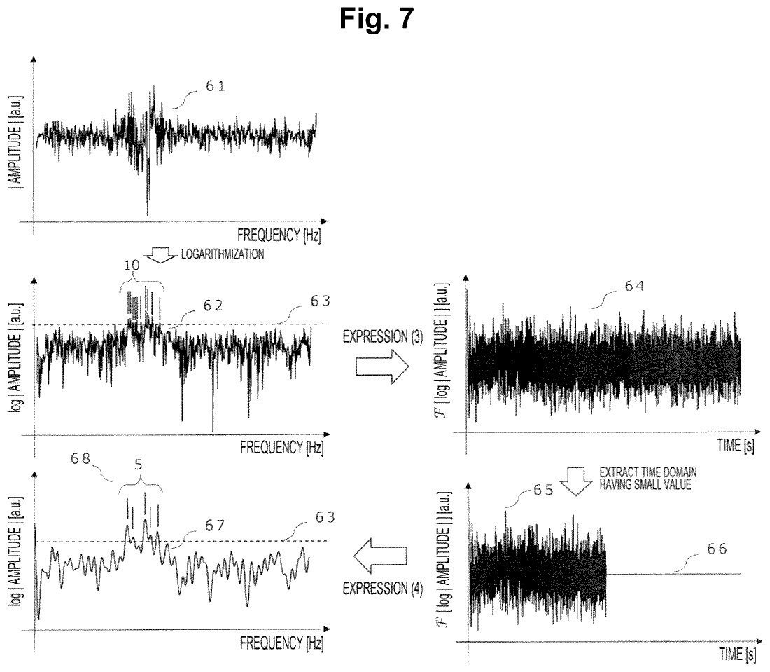

An exemplary embodiment according to the present disclosure will be described below. FIG. 7 is a view illustrating selection and extraction of a feature amount from an envelope of a Fourier spectrum, which is a main point of the present embodiment.

In the first embodiment, peak frequencies and peak amplitudes are obtained from the Fourier spectrum 61 obtained by transforming a change in vibration on the time axis added in the optical fiber longitudinal direction into a change on the frequency axis by Fourier transform, and these are used as feature amounts. When a component having a frequency higher than that of a target frequency component is superimposed on the Fourier spectrum, the superimposition turns a fluctuation appearing in a waveform, and thus, many peaks are detected by the feature extraction unit 212 due to the fluctuation.

In order to compare with the effect of the present embodiment, description will be given using a logarithmized Fourier spectrum waveform 62 obtained by logarithmizing absolute values of the amplitudes of the Fourier spectrum 61. The logarithmization makes it possible to perform calculation processing with the fluctuation regarded as a wave having a period in the frequency axis direction (calculate absolute values of amplitudes before logarithmization to keep information on periodicity).

Here, when a threshold 63 is determined and peak detection is performed on a waveform equal to or greater than the threshold, the peak frequencies and the absolute values (log|amplitude|) of the logarithmized peak amplitudes are the feature vectors of the first embodiment. As an example, in the logarithmized Fourier spectrum waveform 62, the number of peaks exceeding the threshold is 10. Thus, the number of dimensions of the feature vectors of the first embodiment is 20 in total: ten peak frequencies and ten absolute values of the logarithmized peak amplitudes.

In order to remove the fluctuation component in the Fourier spectrum 61, given that the logarithmized Fourier spectrum waveform 62 is set as g(f), the following expression is calculated.

[Math. 4]

$$ℱ ( s ) = {\sum }_{f} g ( f ) exp \{ j [ - 2 π sf ] \} \qquad ( 4 )$$

Here, s is time.

The value (F(s)) 64 of the Fourier transform of the logarithmized Fourier spectrum obtained by the calculation of the expression is a time waveform in which components having a period in the frequency axis direction of the logarithmized Fourier spectrum waveform 62 are plotted on the time axis. Although FFT is used as the Fourier transform formula temporarily, Σ_{f}g(f) cos {2πsf} may be calculated using discrete cosine transform (DCT).

Next, a waveform 65 in a time domain having a value smaller than a predetermined threshold period is extracted from F(s) 64. As the threshold period, any value capable of removing fluctuation can be adopted. In this regard, a waveform 66 other than the extracted waveform may be replaced with an average value of the waveform 65 in the time domain having a small value. Subsequently, the waveform 65 in the time domain having a small value (or the connected waveform of the replaced waveform with the waveform 65 in the time domain having a small value) is set as F′(s), and the following expression is calculated.

[Math. 5]

$${g}^{′} ( f ) = {\sum }_{s} {ℱ}^{′} ( s ) exp \{ j [ 2 π fs ] \} \qquad ( 5 )$$

A spectral envelope 67 of the logarithmized Fourier spectrum waveform from which the fluctuation has been removed can be acquired by transforming the time domain to the frequency domain by the calculation of the expression. This makes it possible to extract feature vectors essential for discriminant of the installation environment of the optical cable. In this regard, inverse Fourier transform (IFFT) may be used as the expression.

Ranges of the magnitude (log|amplitude|) of the logarithmized Fourier spectrum waveform 62 and the spectral envelope 67 are made the same, and the peak detection is performed on the waveform equal to or greater than the threshold 63. The peak frequencies and absolute values (log|amplitude|) of the logarithmized peak amplitudes are set as new feature vectors 68. In the spectral envelope 67, the number of peaks exceeding the threshold is 5. Thus, the number of dimensions of the feature vectors is 10 in total: five peak frequencies and five absolute values of the logarithmized peak amplitudes. Thus, the number of dimensions of the feature vectors can be reduced from 20 to 10 by the processing without losing the essential features. The processing is performed at each point in the optical fiber longitudinal direction.

The categorization and determination are performed using the discriminant dictionary in which learning is performed on the basis of the feature vector selected and extracted from the spectral envelope 67. Examples of the learning method and the categorization determination method include the learning rule and the discriminant function method described in the first embodiment. Hereinafter, a learning method and a categorization determination method using the feature vector will be described in detail.

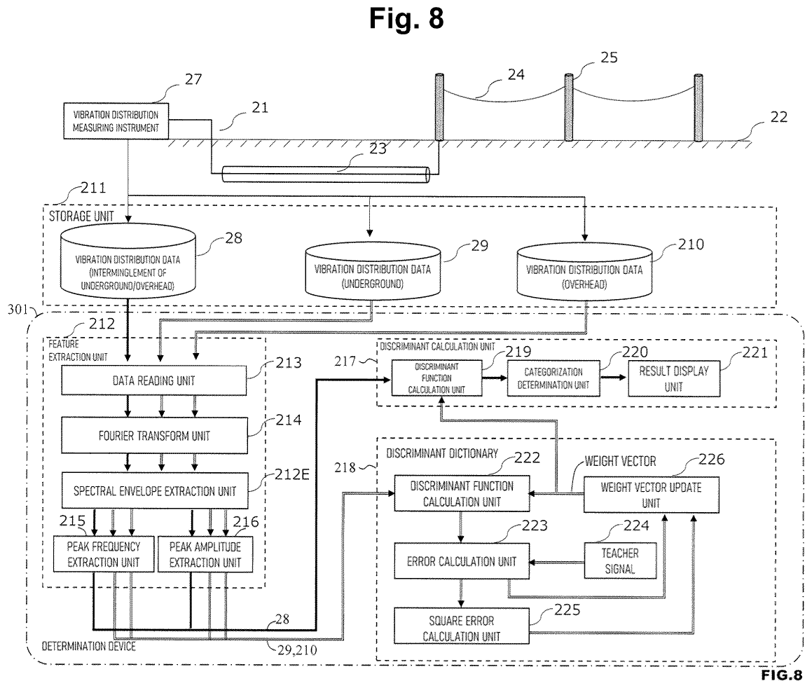

FIG. 8 is a view for explaining the determination device 301 of the present embodiment. In FIG. 8, each reference sign indicates the following. 21: optical cable, 22: ground, 23: underground, 24: overhead, 25: utility pole, 27: vibration distribution measuring instrument, 28: first vibration distribution data, 29: second vibration distribution data, 210: third vibration distribution data, 211: storage unit, 212: feature extraction unit, 213: data reading unit, 214: Fourier transform unit, 212E: spectral envelope extraction unit, 215: peak frequency extraction unit, 216: peak amplitude extraction unit, 217: discriminant calculation unit, 218: discriminant dictionary, 219: discriminant function calculation unit, 220: categorization determination unit, 221: result display unit, 222: discriminant function calculation unit, 223: error calculation unit, 224: teacher signal, 225: square error calculation unit, 226: weight vector update unit.

In the present embodiment, the feature extraction unit 212 includes a spectral envelope extraction unit 212E, and the three-dimensional data of magnitudes of distance-frequency-amplitude of the optical cable (Fourier spectrum data in the optical cable longitudinal direction) transformed by the Fourier transform unit 214 is passed to the spectral envelope extraction unit 212E. As described above, the spectral envelope extraction unit 212E logarithmically transforms the amplitude (magnitude) of the Fourier spectrum at each point in the optical cable longitudinal direction into a time domain by Fourier transform, extracts a component in the time domain having a small value and retransforms the component into a frequency domain, thereby extracting the spectral envelope of the logarithmized Fourier spectrum.

The spectral envelope is passed to the peak frequency extraction unit 215 and the peak amplitude extraction unit 216. The peak frequency extraction unit 215 extracts peak frequencies (x_{d1}, x_{d2}, . . . , x_{dn}) 11 from the spectral envelope of each point in the optical cable longitudinal direction. The peak amplitude extraction unit 216 extracts peak amplitudes (xₐ₁, xₐ₂, . . . , xₐₙ) 12 of the spectral envelope. Moreover, the peak frequencies (xₐ₁, x_{d2}, . . . , x_{dn}) 11 and the peak amplitudes (xₐ₁, xₐ₂, . . . , xₐₙ) 12 of the extracted spectral envelope are passed, as feature values (feature vectors), to a subsequent process.

The feature amounts (feature vectors) of the first vibration distribution data 28 are passed to the discriminant calculation unit 217. The feature amounts (feature vectors) of the second vibration distribution data 29 and the third vibration distribution data 210 are passed to the discriminant dictionary 218.

The feature amounts (feature vectors) of the first vibration distribution data 28 passed to the discriminant calculation unit 217 are passed to the discriminant function calculation unit 219 as input signals, and one output value y 14 is calculated. The output value is the discriminant function. The operation of the discriminant calculation unit 217 and the discriminant dictionary 218 are similar to those in the first embodiment.

### Effects of Present Embodiment

The determination device, the determination method, and the program for determining an installation environment of an optical communication cable according to the present disclosure are considered to have the following advantages.

First, by detecting peak frequencies from the spectral envelope 67 of the logarithmized Fourier spectrum, it is practical to extract the feature amounts essential for the discriminant of the installation environment of the optical cable, which is expected to improve discriminant accuracy.

Secondly, by extracting a feature amount that is essentially necessary, the number of dimensions of the feature vector is reduced, so that calculation resources can be made efficient.

### Third Embodiment

The determination device 301 can also be implemented on a computer and in a program, and the program can be recorded in a recording medium or provided through a network.

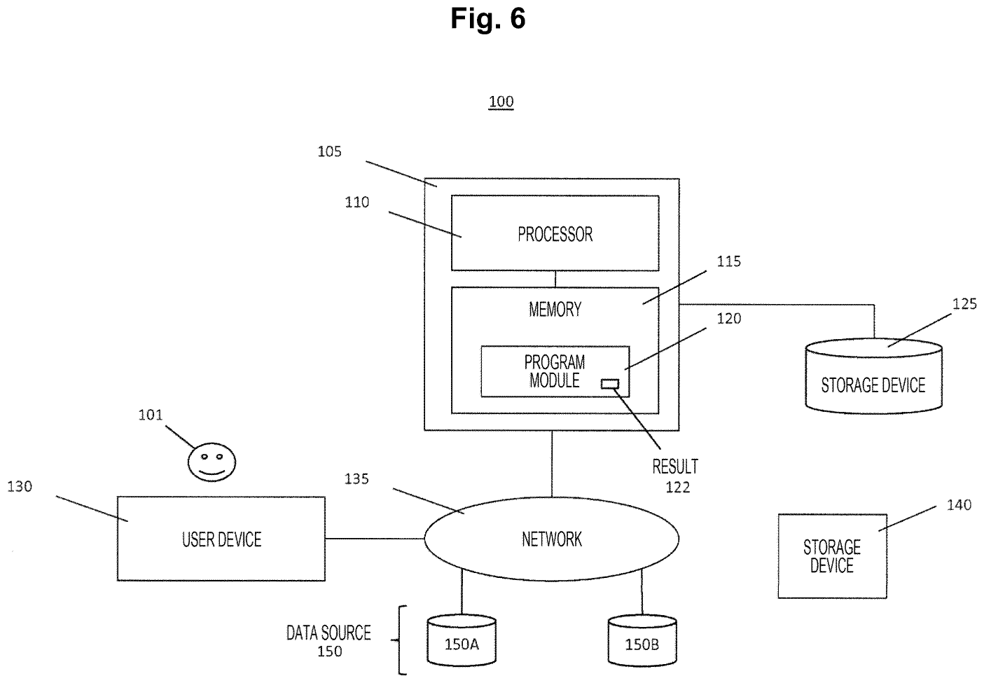

FIG. 6 illustrates a block diagram of a system 100. The system 100 includes a computer 105 connected to a network 135.

The network 135 is a data communication network. The network 135 may be a private network or a public network, and may include any or all of (a) a personal area network, for example, covering a room, (b) a local area network, for example, covering a building, (c) a campus area network, for example, covering a campus, (d) a metropolitan area network, for example, covering a city, (e) a wide area network, for example, covering an area spanning and connecting across boundaries of cities, rural areas, or countries, and (f) the Internet. Communication is performed by using electronic signals and optical signals via the network 135.

The computer 105 includes a processor 110 and a memory 115 connected to the processor 110. The computer 105 is represented herein as a standalone device, but is not limited in this way, and rather may be connected to other devices (not illustrated) in a distributed processing system.

The processor 110 is an electronic device including a logic circuitry that responds to a command and executes the command.

The memory 115 is a tangible computer-readable storage medium in which a computer program is encoded. In this regard, the memory 115 stores data and commands, that is, program codes, which are readable and executable by the processor 110 to control operation of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to perform processes described in the present specification. In the present specification, although it is described that operation is executed by the computer 105, a method, a process, or a sub-process thereof, the operation is actually executed by the processor 110.

The term “module” is used herein to refer to a functional operation that may be embodied either as a stand-alone component or as an integrated configuration of a plurality of sub-components. Thus, the program module 120 can be implemented as a single module or as a plurality of modules that operate in cooperation with each other. Further, in the present specification, although the program module 120 is described as what is installed in the memory 115 and thus implemented in software, the program module 120 can be implemented in any of hardware (for example, an electronic circuit), firmware, software, or a combination thereof.

Although illustrated as already loaded into the memory 115, the program module 120 may be configured to be located on a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive or a memory unit including a plurality of parallel hard drives, and a universal serial bus (USB) flash drive. Alternatively, the storage device 140 may be a random access memory or another type of electronic storage device located in a remote storage system (not illustrated) and connected to the computer 105 via the network 135.

The system 100 further includes a data source 150A and a data source 150B, which are collectively referred to herein as a data source 150 and are communicatively connected to the network 135. In practice, the data source 150 may include any number of data sources, that is, one or more data sources. The data source 150 may include unstructured data and may include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110. The user device 130 further includes an output device such as a display device, a printer, or a speech synthesizer. A cursor control unit such as a mouse, a trackball, or a touch-sensitive screen allows the user 101 to manipulate a cursor on the display device to input further information and command selections to the processor 110.

The processor 110 outputs a result 122 of execution of the program module 120 to the user device 130. Alternatively, the processor 110 may provide the output to a storage device 125, for example, a database or memory, or to a remote device, not illustrated, via the network 135.

For example, the program that performs calculation in FIG. 1 may be used as the program module 120. The system 100 can be operated as the determination device 301.

The term “comprise(s) . . . ” or “comprising . . . ” specifies that the mentioned features, integers, steps, or components are present, but should be understood as what does not exclude the presence of one or more other features, integers, steps, or components, or groups thereof. The terms “a” and “an” are indefinite articles for an object and therefore do not exclude embodiments having a plurality of objects.

### (Other Embodiments)

Note that the present invention is not limited to the above embodiments, and various modifications can be made without departing from the gist of the present invention. In short, the present invention is not limited to the superordinate embodiments perfectly, and in the implementation stage, the components may be modified and embodied without departing from the gist and the scope of the present invention.

In addition, various inventions can be made by appropriately combining a plurality of components disclosed in the above embodiments. For example, some components may be deleted from all the components illustrated in the embodiments. Furthermore, components in different embodiments may be appropriately combined.

### Effects of the Invention

The determination device, the determination method, and the program disclosed in the present specification have the following advantages.

First, by using peak frequencies and peak amplitudes of vibration in the optical cable longitudinal direction as feature amounts and learning a vibration distribution waveform, it is practical to categorize and determine an installation environment of the optical cable into two learned categories.

Secondly, use of this categorization and determination algorithm enables application to categorization and determination of various installation environments of the optical cable such as a position of a utility pole and cable slack as well as underground or overhead.

### REFERENCE SIGNS LIST

11 Peak frequency of Fourier spectrum
12 Peak amplitude of Fourier spectrum
13 Linear sum
14 Output value y
15 Weight vector
21 Optical cable
22 Ground
23 Underground
24 Overhead
25 Utility pole
26 Slack
27 Vibration distribution measuring instrument
28 First vibration distribution data
29 Second vibration distribution data
31 Light intensity distribution
32 Local section
33 Waveform pattern
34 Waveform pattern after Δt seconds
35 Change Δν
41 Waveform g(t)
42 Fourier spectrum
100 System
101 User
105 Computer
110 Processor
115 Memory
120 Program module
122 Result
125 Storage device
130 User device
135 Network
140 Storage device
150 Data source
210 Third vibration distribution data
211 Storage unit
212 Feature extraction unit
212E Spectral envelope extraction unit
213 Data reading unit
214 Fourier transform unit
215 Peak frequency extraction unit
216 Peak amplitude extraction unit
217 Discriminant calculation unit
218 Discriminant dictionary
219 Discriminant function calculation unit
220 Categorization determination unit
221 Result display unit
222 Discriminant function calculation unit
223 Error calculation unit
224 Teacher signal
225 Square error calculation unit
226 Weight vector update unit
301 Determination device

1. A determination device that categorizes an installation environment of an optical cable, the determination device comprising:
a feature extraction unit that extracts a feature vector at each position of the optical cable from a vibration distribution in a longitudinal direction of the optical cable;
a calculation unit that calculates a discriminant function at each position of the optical cable from the feature vector and a weight vector corresponding to the installation environment, in need of categorization, of the optical cable; and
a determination unit that compares the discriminant function with teacher signals representing two states and designates a state of the nearer of the teacher signals as a state of the optical cable, at each position of the optical cable.

2. The determination device according to claim 1, wherein the feature extraction unit Fourier-transforms the vibration distribution from a waveform in a time domain to a spectrum waveform in a frequency domain, extracts frequencies of peaks and respective amplitudes of the peaks from the spectrum waveform and sorts the frequencies and the amplitudes into descending order of the amplitudes of the peaks to obtain the feature vector.

3. The determination device according to claim 1,
wherein the feature extraction unit:
Fourier transforms the vibration distribution from a waveform in a time domain to a spectrum waveform in a frequency domain;
removes a fluctuation component from components having a period in a frequency axis direction of the spectrum waveform;
extracts frequencies of peaks and amplitudes of the peaks from the spectrum waveform from which the fluctuation component has been removed; and
configures the feature vector using the extracted frequencies of the peaks and amplitudes of the peaks.

4. The determination device according to claim 3,
wherein the feature extraction unit removes the fluctuation component by:
logarithmizing absolute values of amplitudes of the spectrum waveform;
calculating a time waveform of components having a period in a frequency axis direction of the logarithmized spectrum waveform from the logarithmized spectrum waveform; and
extracting a time domain having a value smaller than a predetermined threshold period in the time waveform.

5. The determination device according to claim 2,
wherein the weight vector is composed of coefficients for being multiplied by the frequencies and the respective amplitudes of the peaks correspondently, and
the calculation unit adds values obtained by multiplying the frequencies and the respective amplitudes of the peaks by the coefficients of the weight vector correspondently to obtain the discriminant function.

6. The determination device according to claim 1, further comprising:
a discriminant dictionary including a dictionary calculation unit and an update unit,
wherein the feature extraction unit extracts a known feature vector at each position of the optical cable from a vibration distribution in a longitudinal direction of the optical cable in each of the two states,
the dictionary calculation unit calculates a known discriminant function at each position of the optical cable from the known feature vector and the weight vector, and
the update unit calculates, at each position of the optical cable, an error between the known feature vector in each of the two states and the teacher signal representing a relevant state of the two states and updates the weight vector so as to reduce the error.

7. The determination device according to claim 6, wherein the discriminant dictionary settles the weight vector under condition that a square value of the error is a minimum and fluctuation of the error before and after update of the weight vector is equal to or less than a threshold.

8. A determination method for categorizing an installation environment of an optical cable, the determination method comprising:
extracting a feature vector at each position of the optical cable from a vibration distribution in a longitudinal direction of the optical cable;
calculating a discriminant function at each position of the optical cable from the feature vector and a weight vector corresponding to the installation environment, in need of categorization, of the optical cable; and
comparing the discriminant function with teacher signals representing two states and designating a state of the nearer of the teacher signals as a state of the optical cable, at each position of the optical cable.

9. The determination method according to claim 8,
wherein the vibration distribution is Fourier-transformed from a waveform in a time domain to a spectrum waveform in a frequency domain,
a fluctuation component is removed from components having a period in a frequency axis direction of the spectrum waveform,
frequencies of peaks and amplitudes of the peaks are extracted from the spectrum waveform from which the fluctuation component has been removed, and
the feature vector is configured using the extracted frequencies of the peaks and amplitudes of the peaks.

10. The determination method according to claim 9,
wherein the fluctuation component is removed by:
logarithmizing absolute values of amplitudes of the spectrum waveform;
calculating a time waveform of components having a period in a frequency axis direction of the logarithmized spectrum waveform from the logarithmized spectrum waveform; and
extracting a time domain having a value smaller than a predetermined threshold period in the time waveform.

11. The determination method according to claim 8, further comprising:
extracting a known feature vector at each position of the optical cable from a vibration distribution in a longitudinal direction of the optical cable in each of the two states;
calculating a known discriminant function at each position of the optical cable from the known feature vector and the weight vector;
calculating, at each position of the optical cable, an error between the known feature vector in each of the two states and the teacher signal representing a relevant state of the two states; and
updating the weight vector so as to reduce the error.

12. A program for instructing a computer to function as the determination device according to claim 1.
